(19) United States
(12) Patent Application Publication
(10) Pub. No.: US 2003/0053574 A1
(43) Pub. Date: Mar. 20, 2003

(54) Adaptive sampling

(76) Inventors: Shai Cohen, Haifa (IL); Alon Webman, Kiryat Ono (IL); Ronnen Lovinger, Ra'anana (IL)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/169,269

(22) PCT Filed: Dec. 28, 2000
(86) PCT No.: PCT/IL00/00870

(51) Int. Cl. H04L 7/00

(52) U.S. Cl. 375/355; 375/365

(57) ABSTRACT

A method for sampling a data stream (22) includes receiving a segment of the data stream containing a sequence of known data, together with a source-synchronous clock signal (20), and generating a series of trial sampling clocks (60) by applying a corresponding series of different trial delays to the received clock signal The received segment of the data stream is sampled using each of the trial sampling clocks in turn to generate sampled data. The known data are compared to the sampled data to find comparison results for each of the trial sampling clocks. Responsive to the comparison results, a final delay is set, to be applied to the received clock signal so as to generate a final sampling clock for use in sampling the data stream subsequent to the segment.

### CROSS-REFERENCE TO RELATED APPLICATIONS

This application claims the benefit of U.S. Provisional Patent Application No. 60/173,226, filed Dec. 28, 1999, which is assigned to the assignee of the present patent application and is incorporated herein by reference.

### FIELD OF THE INVENTION

The present invention relates generally to electronic circuits and devices, and, specifically to high-speed communication devices.

### BACKGROUND OF THE INVENTION

High speed integrated electronic devices are making increasing use of source-simultaneous timing methods. In these methods, a transmitting device sends data together with a clock signal to a receiving device. The receiving device uses the clock signal to time its sampling of the data. In “source-centered” timing, the transmitted data are valid in a time window that is centered on a transition of the clock. In “double data rate” (DDR) systems, the data are transmitted on both of the clock edges. In “source-simultaneous” timing, the data validity windows are aligned with high and/or low phases of the clock. In receiving devices known in the art, a phase-locked loop (PLL) is typically used to recover a sampling clock from the clock signal, so that the data can he sampled at the proper time during the validity window.

FIG. 1 is a timing diagram that schematically illustrates source-simultaneous timing of transmitted data 22 relative to a sampling clock signal 20. Valid data 30 are transmitted in this example during a nominal validity period Tcv, which is aligned with a high phase 26 of the clock. During transition periods Tct, which are nominally associated with rising edges 23 and falling edges 28 of the clock, the data are considered to be invalid, as represented by a hatched area 32. Tcv and Tct together sum to the duration of one phase of the sampling clock. For example, at a data rate of 125 MHz, as is commonly used in high-speed communication devices today, this means that Tcv+Tct=4 ns.

Ideally, if the sampling clock and the data were perfectly synchronized, Tct would represent the only time in each clock phase during which the data are not valid. It would then be possible for the receiving device to sample the data at any point during the nominal validity period Tcv between the rising and falling clock transitions. As indicated by the multiple rising edges 23 and falling edges 28 in the figure, however, there is inevitably a certain amount of variability and uncertainty between the clock and the data that arrive at the receiving device. Reasons for this variability include:

Process technology variations—integrated circuit elements located on different parts of a wafer may operate at markedly different speeds due to inconsistencies in fabrication conditions.

Variations in the supply voltage powering the transmitting and/or receiving device.

Variations in operating temperature.

Differences in length between traces carrying the data and those carrying the clock signals on a printed circuit board or in an integrated circuit device package.

Noise and other imperfections in signal integrity.

It is estimated that the combined effects of process technology, voltage and temperature variations may increase the relative delay of a buffer holding the data by as much as 2.5:1 compared to a nominal delay. In other words, if the nominal maximum uncertainty time Tct is 1.5 ns, as is typical in 125 MHz devices, the actual uncertainty may be as much as 3.75 ns. Sampling the data at an arbitrary time in the Tcv window may give unstable or erroneous results. There is therefore a need for the receiver to be able to vary the actual delay at which it samples the data relative to the sampling clock in order to find an optimal sampling point. In the present example, it is desirable that the range of the delay be variable from 0 to 3.75 ns, i.e., over a range considerably greater than the nominal value of Tct.

### SUMMARY OF THE INVENTION

It is an object of some aspects of the present invention to provide improved methods and devices for sampling high-speed signals.

It is a further object of some aspects of the present invention to provide a method for adaptive optimization of sampling time by a receiver of a source-synchronous signal.

It is yet a further object of some aspects of the present invention to provide an improved adaptive sampling circuit for use in receiving and sampling source-synchronous signals.

In preferred embodiments of the present invention, a high-speed data receiver receives an input data stream sent by a transmitter together with a source-synchronous clock signal, typically a source-simultaneous clock signal. The data stream begins with a sequence of known data, such as a handshake sequence, as is common in communication protocols known in the art. The receiver generates a sampling clock by applying a variable delay to the received clock signal. In order to find the optimal delay, the receiver applies a succession of different delays to the clock signal, so as to generate a series of different trial sampling clocks. The receiver samples the known data sequence in the data stream using each of the trial clocks in the series. The sampled data for each different trial clock are compared to the known data, to determine whether sampling at the corresponding clock delay captured the data in the sequence correctly or erroneously. The results of this comparison are processed to find an optimal clock delay, which is then used to generate the sampling clock in an ensuing communication session between the transmitter and the receiver.

The methods of the present invention are particularly advantageous in source-simultaneous timing, as well as in the related area of double data rate (DDR) timing, because in these schemes, timing imprecision can easily lead to a loss of sampling accuracy. The principles of the present invention are also applicable, however, to other timing schemes, such as source-centered timing.

There is therefore provided, in accordance with a preferred embodiment of the present invention, a method for sampling a data stream, including:

receiving a segment of the data stream containing a sequence of known data, together with a source-synchronous clock signal, preferably a source-simultaneous clock signal;

generating a series of trial sampling clocks by applying a corresponding series of different trial delays to the received clock signal;

sampling the received segment of the data stream using each of the trial sampling clocks in turn to generate sampled data;

comparing the known data to the sampled data to find comparison results for each of the trial sampling clocks; and

responsive to the comparison results, setting a final delay to be applied to the received clock signal so as to generate a final sampling clock for use in sampling the data stream subsequent to the segment.

Preferably, the data stream is transmitted in accordance with a predetermined protocol, and receiving the segment of the data stream includes receiving a segment containing a handshake sequence in accordance with the protocol.

Additionally or alternatively, comparing the known data includes marking as valid one or more of the trial sampling clocks for which the sampled data were equal to the known data, wherein setting the final delay includes choosing a delay within a range of delays defined by the trial delays corresponding to the one or more valid trial sampling clocks.

There is also provided, in accordance with a preferred embodiment of the present invention, a high-speed data receiver, adapted to receive a data stream together with a source-synchronous clock signal, the receiver including:

a variable delay generator, coupled to receive the source-synchronous clock signal and to apply a variable delay thereto so as to generate a sampling clock;

a sampling device, adapted to sample the data stream responsive to the sampling clock, so as to generate sampled data;

a clock selector, operative to drive the variable delay generator to generate a series of trial versions of the sampling clock by applying a corresponding series of different trial delays to the received clock signal while the receiver is receiving a segment of the data stream containing a sequence of known data;

a comparator, operative to compare the known data to the sampled data generated by the sampling device responsive to the segment of the data stream containing the known data sequence using each of the series of trial versions of the sampling clock, thus generating respective comparison results; and

optimization logic, operative responsive to the comparison results to set a final delay to be applied by the variable delay generator for sampling the data stream subsequent to the segment containing the known data sequence.

The present invention will be more fully understood from the following detailed description of the preferred embodiments thereof, taken together with the drawings in which:

### BRIEF DESCRIPTION OF THE DRAWINGS

FIG. 1 is a timing diagram that schematically illustrates source-simultaneous timing of transmitted data relative to a sampling clock signal;

FIG. 2 is a block diagram that schematically illustrates an adaptive data receiver, in accordance with a preferred embodiment of the present invention;

FIG. 3 is a timing diagram that schematically illustrates trial clock signals and data that are sampled using the trial clock signals, in accordance with a preferred embodiment of the present invention;

FIG. 4 is a state diagram that schematically illustrates a method for determining an optimal clock delay, in accordance with a preferred embodiment of the present invention; and

FIG. 5 is a block diagram that schematically illustrates a high-speed data transceiver, in accordance with a preferred embodiment of the present invention.

### DETAILED DESCRIPTION OF PREFERRED EMBODIMENTS

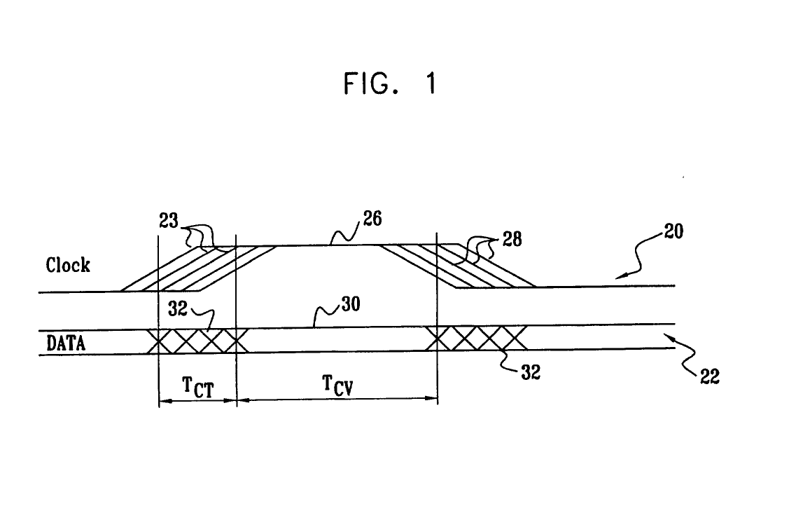

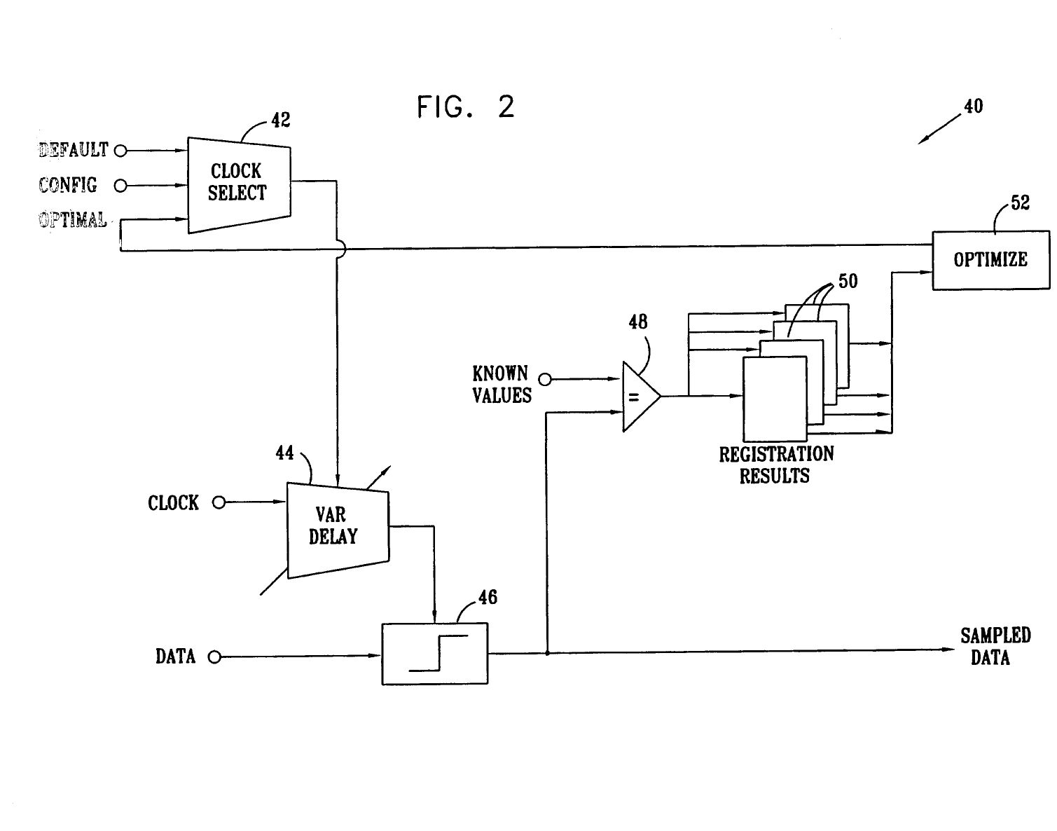

FIG. 2 is a block diagram that schematically illustrates an adaptive data receiver 40, in accordance with a preferred embodiment of the present invention. The receiver receives an input data stream and a source-simultaneous clock signal from a transmitter (not shown), as shown in FIG. 1, for example. A variable delay generator 44 applies a selected delay to the received clock signal in order to generate a sampling clock. The delay is controlled by a clock selector 42, operating in conjunction with a comparator 48, registers 50 and optimization logic 52, as described hereinbelow. A decision device 46 samples the data stream, at sampling times determined by the sampling clock, to generate an output bitstream of sampled data.

When receiver 40 is turned on, clock selector 42 is initially set to a default value. During an adaptation procedure, as described hereinbelow, the clock selector drives delay generator 44 to apply a series of different trial delays to the clock signal. This adaptation procedure takes place while the transmitter is sending a known data sequence, typically a handshake sequence used to establish a link between the transmitter and receiver. Such a sequence is prescribed, for example, by the InfiniBand protocol, as well as by most other communication protocols known in the art. Comparator 48 compares the sampled data in the output bitstream to the known data sequence at each of the different delays. The results of the comparison are stored in registers 50.

After selector 42 has cycled delay generator 44 through a complete range of trial delays, optimization logic 52 reads the stored results and determines an optimal clock delay. This is typically the delay that is expected to give the most reliable results in sampling the data from the transmitter. The optimal delay selection is conveyed by logic 52 to selector 42 and is used to control sampling of the unknown data received thereafter from the transmitter.

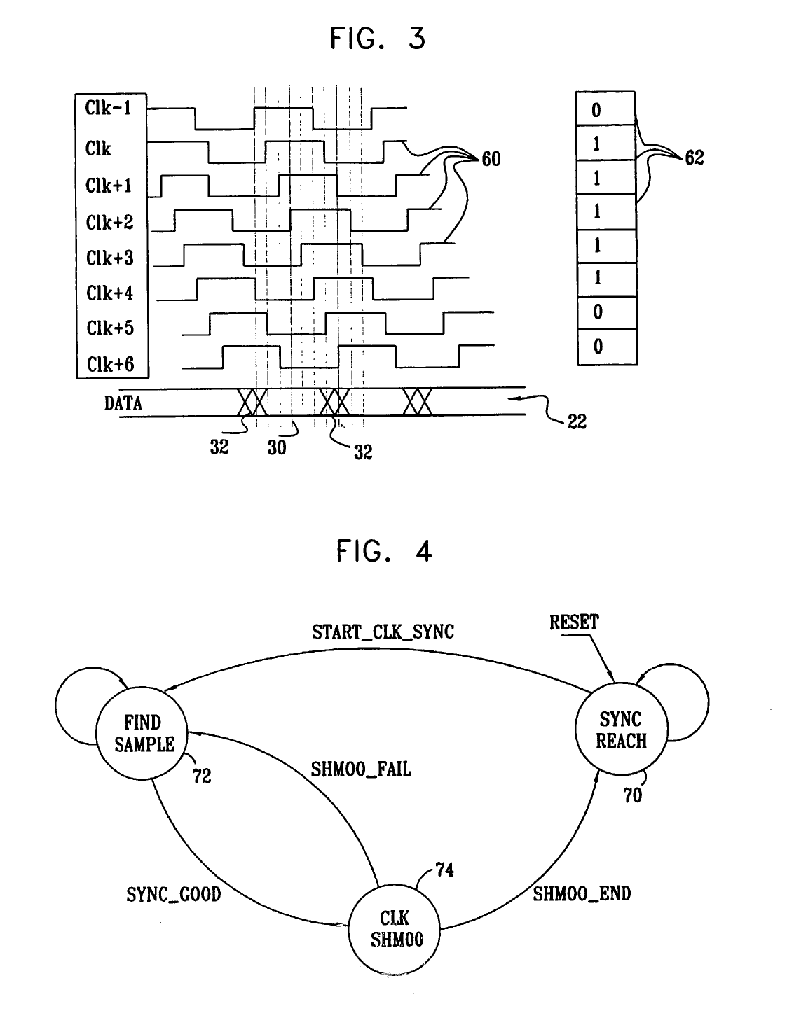

FIG. 3 is a timing diagram that schematically illustrates a series of trial sampling clocks 60 generated by delay generator 44 during the above-mentioned adaptation procedure, in accordance with a preferred embodiment of the present invention. The figure also shows transmitted data 22, including valid data 30 and hatched areas 32 representing periods during which the data are invalid. In this example, seven different trial clocks 60 are provided, with different relative delays spanning the duration of one phase of the data. In the example cited in the Background of the Invention, in which each phase of the data has a duration of 4 ns, the delays of the different clocks are spaced about 0.5 ns apart. It will be understood, however, that a greater or lesser number of different trial clocks 60 may be used, with smaller or larger separation between the different delays, as dictated by the operational requirements and constraints placed on the receiver. A preferred realization of delay generator 44 is described in the above-mentioned U.S. provisional patent application and in a PCT patent application, filed on even date, entitled “Duty Cycle Adapter,” which is assigned to the assignee of the present patent application and is incorporated herein by reference. Other possible implementations will be apparent to those skilled in the art.

For each of trial clocks 60, a table at the right side of FIG. 3 shows corresponding sampling results 62 determined by comparator 48. A result of “1” indicates that the data were sampled correctly, i.e., that the sequence of data values output by decision device 46 using this particular trial clock agreed with the known sequence. For the sake of simplicity of illustration, the clocks whose rising edge falls within the period of valid data 30 have results of “1”. The remaining clocks have results of “0”, indicating inconsistency between the sampled and known data values. Logic 52 will therefore preferably choose a delay in the range between Clk and Clk+4, which gave valid results and thus define a valid sampling window.

The optimal choice of delay is typically a function of operating conditions and constraints. Preferably, the delay is chosen to provide the required amount of times for data setup, and for holding the data to be sampled. These times depend on the characteristics of device 46 (which is typically a flip-flop). The times are chosen to allow maximal robustness of sampling in the face of drifts that may occur due to operating conditions. Typically, the center trial clock in the valid range is taken as a starting point (Clk+2 in the present example), and the actual working delay is shifted by one or two delay steps forward or back from this point depending on the required setup and hold times. For instance, if the setup time is considerably greater than the hold time, Clk+3 might be found to represent the optimal clock delay. Depending on the granularity of adjustment afforded by delay generator 44, it may also be possible for logic 52 to choose an intermediate delay value, in between two of trial clocks 60.

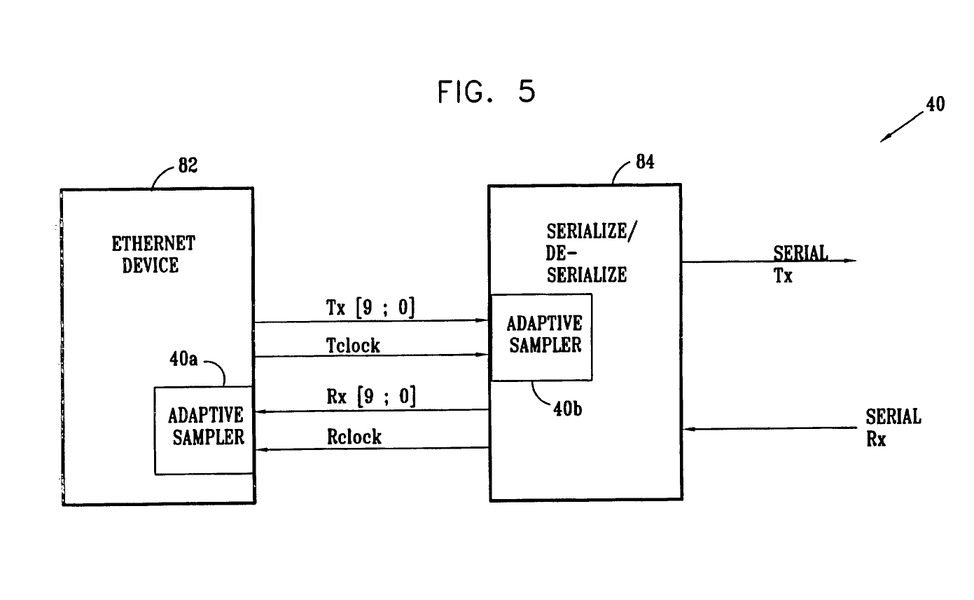

FIG. 4 is a state diagram that schematically illustrates a method for determining the optimal clock delay for receiver 40, in accordance with a preferred embodiment of the present invention. In a find sample state 72, selector 42 cycles through all of the different trial clock delays, and the sampling results are determined, as described above. When at least one of the trial sampling clocks gives valid sampling (i.e., result 62 equal to “1”), the receiver passes to the next state, labeled clock shmoo state 74. Otherwise, the receiver remains in state 72 until data are received and sampled correctly.

In state 74, an additional iteration is preferably performed through all of the sampling clocks in order to ensure that the results of state 72 are correct. This iteration is required particularly when valid sampling results in state 72 were not obtained over a wide, unbroken range of different clock delays (unlike the situation shown in FIG. 3). In such a case, the results of state 72 may be incorrect. Therefore, in state 74, each of the different clocks is used to sample the data multiple times. Once it is ascertained that the results are correct and consistent, logic 52 is allowed to choose the optimal delay for the sampling clock. Should this process fail, the receiver returns to state 72 to try again.

Once the process of delay checking and optimization in state 74 has been completed, the receiver moves on to a synchronization reached state 70. In this state, the optimal clock is used to sample the data stream from the transmitter. The receiver remains in this state until it is switched off or reset, due to a system failure, for example. At startup or reset of the receiver, it begins operation in state 70 with a default delay value. Upon receiving a start-clock-synchronization signal, the receiver enters state 72, and the process of delay optimization begins as described above.

FIG. 5 is a block diagram that schematically illustrates a high-speed data transceiver 80, as an example of the use of adaptive sampling in accordance with a preferred embodiment of the present invention. Transceiver 80 is designed to provide Ethernet communications over a Fiber Channel serial link. Other applications of the adaptive sampling methods and receiver circuitry of the present invention will be apparent to those skilled in the art.

Transceiver 80 comprises an Ethernet device 82, which communicates over a 10-bit parallel interface with a physical layer device 84. The physical layer device serializes the transmitted data sent by the Ethernet device for transmission over the serial link and de-serializes the received data. After de-serialization, device 84 transmits the resultant 10-bit Rx data to an adaptive sampling receiver 40a, along with a source-simultaneous clock signal Rclock. Similarly, Ethernet device 82 sends 10-bit Tx data along with a source-simultaneous clock signal Tclock to an adaptive sampling receiver 40b. Alternatively, it may be that only one of devices 82 and 84 transmits in a source-simultaneous mode.

Receivers 40a and 40b are functionally similar to receiver 40 shown in FIG. 2. When transceiver 80 is turned on, devices 82 and 84 transmit known data patterns to one another, preferably as specified by the Ethernet link protocol. These known data patterns are used to find the optimal adaptive sampling delays from receivers 40a and 40b, substantially in the manner described hereinabove. By contrast, in transceivers known in the art, each of devices 82 and 84 must include a costly, and not always reliable, phase-locked loop (PLL) in order to recover the sampling clock from the received clock signals.

Although preferred embodiments are described herein with reference to source-simultaneous data transmission, the principles of the present invention may similarly be applied to other modes of data transmission, particularly source-synchronous data transmission. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for sampling a data stream, comprising:
receiving a segment of the data stream containing a sequence of known data, together with a source-synchronous clock signal;
generating a series of trial sampling clocks by applying a corresponding series of different trial delays to the received clock signal;
sampling the received segment of the data stream using each of the trial sampling clocks in turn to generate sampled data;
comparing the known data to the sampled data to find comparison results for each of the trial sampling clocks; and
responsive to the comparison results, setting a final delay to be applied to the received clock signal so as to generate a final sampling clock for use in sampling the data stream subsequent to the segment.

2. A method according to claim 1, wherein the source-synchronous clock signal comprises a source-simultaneous clock signal.

3. A method according to claim 1, wherein the data stream is transmitted in accordance with a predetermined protocol, and wherein receiving the segment of the data stream comprises receiving a segment containing a handshake sequence in accordance with the protocol.

4. A method according to any of claims 1-3, wherein comparing the known data comprises marking as valid one or more of the trial sampling clocks for which the sampled data were equal to the known data.

5. A method according to claim 4, wherein setting the final delay comprises choosing a delay within a range of delays defined by the trial delays corresponding to the one or more valid trial sampling clocks.

6. A high-speed data receiver, adapted to receive a data stream together with a source-synchronous clock signal, the receiver comprising:
a variable delay generator, coupled to receive the source-synchronous clock signal and to apply a variable delay thereto so as to generate a sampling clock;
a sampling device, adapted to sample the data stream responsive to the sampling clock, so as to generate sampled data;
a clock selector, operative to drive the variable delay generator to generate a series of trial versions of the sampling clock by applying a corresponding series of different trial delays to the received clock signal while the receiver is receiving a segment of the data stream containing a sequence of known data;
a comparator, operative to compare the known data to the sampled data generated by the sampling device responsive to the segment of the data stream containing the known data sequence using each of the series of trial versions of the sampling clock, thus generating respective comparison results; and
optimization logic, operative responsive to the comparison results to set a final delay to be applied by the variable delay generator for sampling the data stream subsequent to the segment containing the known data sequence.

7. A receiver according to claim 6, wherein the source-synchronous clock signal comprises a source-simultaneous clock signal.

8. A receiver according to claim 6, wherein the data stream is transmitted in accordance with a predetermined protocol, and wherein the sequence of known data comprises a handshake sequence in accordance with the protocol.

9. A receiver according to any of claims 6-8, wherein the comparator is adapted to mark as valid one or more of the trial versions of the sampling clock for which the sampled data were equal to the known data.

10. A receiver according to claim 9, wherein the optimization logic is adapted to set the final delay to be within a range of delays defined by the trial versions corresponding to the one or more valid trial sampling clocks.
